(19) United States
(12) Patent Application Publication
(10) Pub. No.: US 2020/0027156 A1
(43) Pub. Date: Jan. 23, 2020

(54) METHODS AND SYSTEMS FOR ONLINE AUCTIONING OF ITEMS

(71) Applicant: Wesley Palmer GAVIN, New York, NY (US)

(72) Inventor: Wesley Palmer GAVIN, New York, NY (US)

(21) Appl. No.: 16/038,123

(22) Filed: Jul. 17, 2018

(51) Int. Cl. G06Q 30/08; G06Q 20/40; G06Q 10/02; G06F 21/32

(52) U.S. Cl. CPC G06Q 30/08; G06F 21/32; G06Q 10/02; G06Q 20/407

(57) ABSTRACT

The present invention provides a system and method for facilitating an online auction of a plurality of items. The method includes determining an item ranking to each of the items to be auctioned in the online auction. The method includes dynamically receiving bids from a plurality of users, where each bid includes a payment value representing an interest of purchase for at least one item from among the plurality of items. The method further includes dynamically determining a bid ranking of each bid from the plurality of users. The bid rankings are determined based on a function of the payment value corresponding to respective bid. The method further includes determining a winning bid for each item from among the bids received from the users. Once the winning bid is determined, the method further includes determining a mapping of the items and a winning bid for each of the items.

### TECHNICAL FIELD

The present disclosure generally relates to an online auction platform for allowing the sale of items through a platform to multiple users.

### BACKGROUND

Online auction systems are gaining popularity over time and have multiple advantages when compared to traditional auctioning methods. For example, bids can be placed from the comfort of one's own home and there are no geographical constraints. Due to such ease of access, there is a larger pool of participants, contributing towards the creation of strong auctioning networks that are changing the course of buying and selling in the present day.

Though online auction system sounds convenient, there are numerous challenges which are not being addressed by current online auction systems. Major problems with current systems are associated with market and pricing inefficiencies. There is a disparity between consumer willingness to pay and the actual market price decided for an item or good. As a result, the present systems fail to capture nearly as much revenue as they are capable of extracting, due to a disconnect between the customers' willingness to pay for items and the system's determination of prices. This disparity is present at all levels of pricing, from low quality to high quality goods. The inefficient pricing leads to deadweight loss, as a certain quantity of items remains unsold. One of the major downsides of such inefficiencies is that it leads to the existence of secondary markets. Secondary markets, such as scalping markets, take advantage of the price difference between the market price and consumer's willingness to pay. For instance, a scalping software will purchase items (e.g., tickets) for high demand events at the time the tickets go on sale, and then arbitrage the tickets at a higher price in the secondary market. Once the tickets move to secondary markets, the first-level sellers make no additional profit, but the secondary markets will continue to profit off from the resale of the tickets.

In light of the above-mentioned challenges, there is a need for a technique that can capture maximum profits in a single round of sales. Further, the technique should be disruptive; capable of pricing the items at the correct price-point in the first time itself rather than allowing profits to be siphoned into the secondary market.

### SUMMARY

In one embodiment, a method for facilitating an online auction of a plurality of items is disclosed. The method includes accessing an item ranking of each of the plurality of items to be auctioned in the online auction. Each of the plurality of items belongs to an item type from among a set of item types. Further, the method dynamically receives bids from a plurality of users. Each bid includes a payment value, where the payment value represents an interest of purchase for at least one item from among the plurality of items. A bid ranking is dynamically determined for each bid received from the plurality of users. The bid ranking is calculated based on a function of the payment value corresponding to respective bid and at least one item is chosen in a bid. After calculating the bid ranking, winning bids for the plurality of items is determined from among the bids received from the plurality of users, wherein a winning bid for an item is determined from a set of bids for the item, and wherein the winning bid is determined based on a function of a set of bid rankings for the set of bids for the item, the item ranking, and information of preference of the item in the set of bids. Once the winning bid is determined, a mapping of each of the plurality of items and corresponding winning bid for each of the plurality of items is determined.

In another embodiment, a system for facilitating an online auction of a plurality of items is disclosed. The system includes a communication module, a database and a processor. The communication module is configured to communicate with a plurality of user devices. The database is configured to store instructions related to execution of online auction. The processor is configured to execute the stored instructions to perform a method of facilitating the online auction of the plurality of items. The method includes accessing an item ranking to each of the plurality of items to be auctioned in the online auction. Each of the plurality of items belongs to an item type from among a set of item types. Further, the method dynamically receives bids from a plurality of users. Each bid includes a payment value, where the payment value represents an interest of purchase for at least one item from among the plurality of items. A bid ranking is dynamically determined for each bid received from the plurality of users. The bid ranking is calculated based on a function of the payment value corresponding to respective bid and at least one item chosen in a bid (for example, a number of items chosen in the bid). After calculating the bid rankings, a winning bid for each item of the plurality of items is determined from among the bids received from the plurality of users wherein a winning bid for an item is determined among a set of bids for the item, and wherein the winning bid is determined based on a function of a set of bid rankings for the set of bids for the item, the item ranking and information of preference of the item in the set of bids. Once the winning bid is determined, a mapping of each of the plurality of items and corresponding winning bid for each of the plurality of items is determined.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 shows a simplified representation of an environment showing an online auctioning system configured with a user device, a server and a third-party server, related to at least some example embodiments;

FIG. 2A shows a simplified schematic representation of a user interface in the user device for placing a bid, in accordance with an example embodiment;

FIG. 2B shows a simplified schematic representation of a user interface displaying an interactive map view of an event and details associated with seats in the user device, in accordance with an example embodiment;

FIG. 3 shows an example flow diagram of a method of calculation of a rank of user and dynamic update of the rank of user, in accordance with an example embodiment;

FIG. 4 shows a flow diagram representing execution of an auction of a plurality of items, in accordance with at least some example embodiments;

FIG. 5 shows another simplified schematic representation of an auction process, in accordance with an example embodiment;

FIG. 6 is a flow diagram of a method for facilitating an online auction of a plurality of items, in accordance with an example embodiment;

FIG. 7 is a simplified block diagram representation of a server for facilitating an online auction, in accordance with an example embodiment; and

FIG. 8 is a simplified block diagram representation of a user device involved in an online auction, in accordance with an example embodiment.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “item” used throughout the present disclosure refers to, but not limited to, any product or service available for bidding by a user. In a preferred embodiment, ‘item’ may be referred to tickets/entry passes to any event such as movie, play, sports, transportation ticket including airlines, trains, buses, cab services and the like.

The term “user device” used throughout the present disclosure refers to any computing device that is configured with a user interface which further enables the user to access an auction platform remotely. The user device may be a cell phone, laptop, tablet, desktop computer, smart devices, and the like.

The term “auction platform” used throughout the present disclosure refers to a computer application that is configured within a server and/or user device, where the auction platform is configured to set up and carry out an online auction process.

### Overview

Various embodiments of the present disclosure provide methods and systems for facilitating an online auction of items. The items can take examples of any goods or services such as tickets for events such as a concert, a football match, a movie, etc. Embodiments provide an online auction platform in the form of an application which can be used by multiple users on their respective user devices. Users, by accessing the application of the online auction platform, can see the items available for bids, select the items of interest, and place their bids. Users will have an option to update their bids while the online auction is still in progress, and maintain full transparency into their bids' ranking in the auction. While receiving bids from users, the platform dynamically calculates the ranks of the users (i.e. a user ranking) based on their respective bids. A ‘user ranking’ and ‘user rank’ for a respective bid is also interchangeably referred to as ‘bid ranking’ throughout the description.

The items in the online auction platform may have respective ranks depending on factors like quality of items. For instance, in case of items being event tickets, front row event tickets may have a higher item ranking as compared to the tickets of the last row. The online auction platform accesses the item ranking of each item of the online auction, and accepts bids from the users. The users may have an option of specifying their preference of items along with their bids. The online auction platform takes user rankings (or bid rankings) into consideration and matches user rankings with the item rankings. In some cases, while assigning items to specific users, the platform may also consider preference given by each user and determines how each item should be allocated among the users. The platform also provides the users with an option to resell the purchased items. If a purchased item from the online auction platform is no longer needed, the platform allows the user to resell the items via the platform itself.

If the items to be auctioned are the tickets for an event, then the platform provides an interactive map of an event. The map shows the seating arrangements to the users, where the users can see views and sight lines from specific seating locations. In some scenarios, the tickets can also be linked with the specific users by using any known biometric authentication technologies. While bidding for specific tickets, the platform collects the biometric data of the users and when the users enter the event venue, they are required to confirm their identity against this information. The biometric data can be any of fingerprint, retina scan data, facial features, and the like.

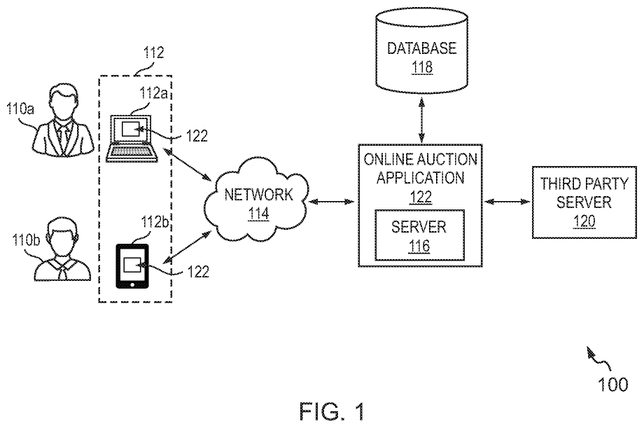

Various embodiments of methods and systems for facilitating an online auction process are explained herein with reference to FIG. 1 to FIG. 8.

FIG. 1 shows a simplified representation of an environment showing an online auction system 100 configured with a plurality of user devices exemplarily shown as user devices 112a, 112b (associated with users 110a and 110b, respectively), a server 116 and a third party server 120, related to at least some example embodiments. The server 116 is configured to host and/or manage an auction platform for facilitating an online auction application (see, 122) for enabling various users to perform biding and buying of items. The auction application 122 can be made available to the user devices 112a, 112b either by way of allowing the user devices 112a, 112b to download the application 122 associated with the auction platform from various sources. For instance, the application 122 can be downloaded from application stores such as Google Play store managed by Google®, Apple App store managed by Apple®, from websites, and the like. In some cases, the application 122 may be factory installed in the user devices 112a, 112b by respective manufacturers. Additionally or alternatively, the auction application 122 can be accessed through the user devices 112a, 112b through channels such as web browsing.

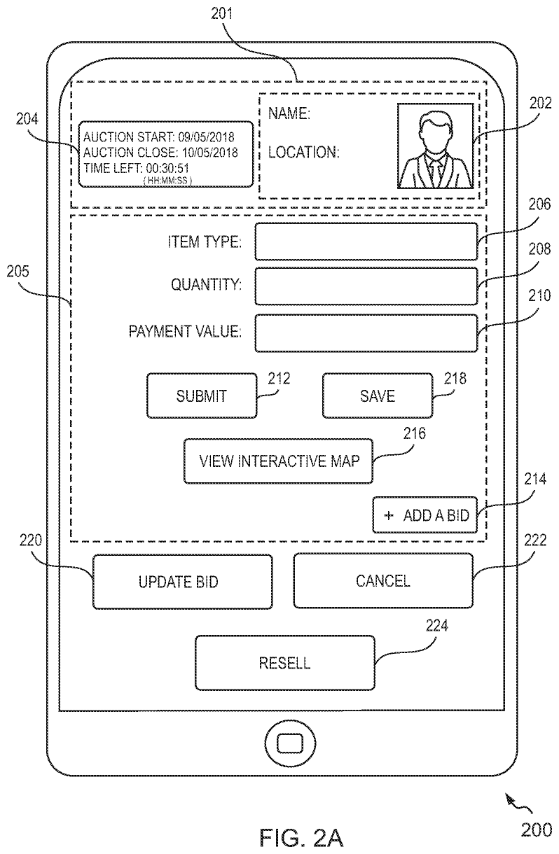

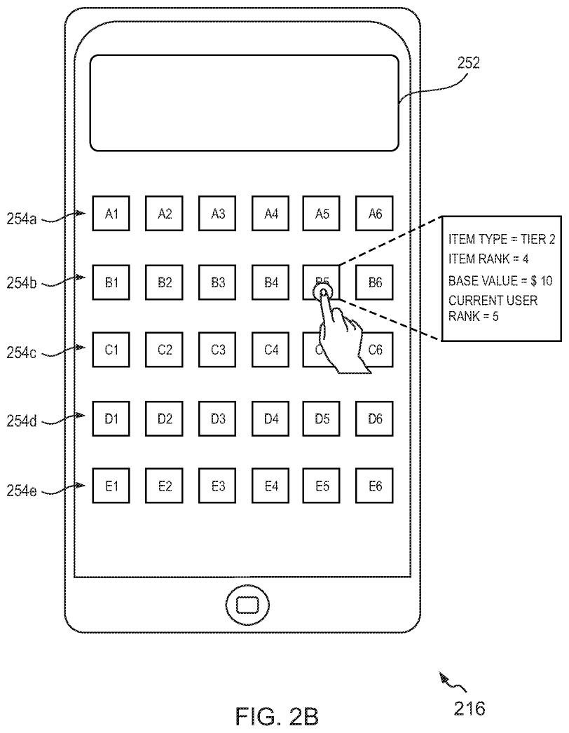

The system 100 facilitates online auctioning of a plurality of items, which can be of different item types. For instance, in an example of the items being event tickets, event tickets may be clustered into different item types. For example, front row tickets may be of one item type, second row of another item type, and so on. It should be noted that the item types can be defined by the organizers of the event (i.e., by the third party server 120) based on a plurality of factors such as historical data of sale of tickets, demand/supply of items, user's interest, quality of individual items, etc. For instance, middle three tickets of the front row may have one item type and other tickets of the front row may be of another item type. An example representation of items of various item types is further shown and described with reference to FIG. 2B.

In one embodiment, the server 116 is configured to receive information of a plurality of items from the third party server 120. The third party server 120 may be systems associated with actual sellers of the items, for example, event organizers in case of items being event tickets. Once the information/details of the items are provided by the third part server 120 to the server 116, the server 116 finalizes an overall quantity of plurality of items available for the auction. Further, the server 116 differentiates the plurality of items and groups them based on the quality of the items or tier of the items (simply known as ‘item types’). For example, consider the plurality of items are tickets for an event, once the total quantity of the tickets is established, the server 116 differentiates among the tickets and accordingly groups the tickets into front, middle and back rows, and the like. In a non-limiting example, the front rows seats may be considered as tier 1, middle rows seats as tier 2 and back rows as tier 3. In one example, tiers represent item type. It should be noted that the item type may be directly received from the third party server 120, or the server 116 determines the item types from the plurality of items based on historical data associated with an online auction of similar items.

After tiering (i.e. grouping into item types), the server 116 ranks each of plurality of items based on the quality of the items or qualitative analysis of the items. For example, out of 60 tickets, the server 116 may group first 20 as front row seats or tier 1, next 20 as middle row seats or tier 2 and last 20 as back row seats or tier 3. In this example, a pre-determined number of middle seats in the first row may be assigned with 1^{st} rank, front first row corner seats are assigned with 2^{nd} rank, front second row middle seats are ranked 3^{rd}, front second row corner seats are ranked 4^{th}, middles seats of the first middle row are ranked 5^{th} and so forth. As mentioned earlier, the item ranking is purely based on qualitative analysis of the items, and analysis parameters may change for a set of types of items based on various factors. Further, each of plurality of items are assigned with at least one attribute, where the attribute generally defines the rank, item type and other specific details of an item. For example, the attributes of an item may be row number, seating location, item type, handicap access, price based on the item type and the like.

The server 116 updates a database 118 with the plurality of items, where each item is associated with corresponding item specific attributes including ranking. The database 118 may alternatively be called as an auction database 118. Once all the details associated with the items is established, the auction period is established with a definite start and stop time. In one embodiment, item details may also include pre-decided cost or base price of each item. For example, let us consider items are tickets for a play, the server 116 groups the tickets into three item types, tier 1, tier 2 and tier 3. Each ticket of each item type is specified with a base price which is, $15 for tier 1 seat, $10 for tier 2 seat and $7 for tier 3 seat. The base price can be based on the marginal operation cost (MCO) of the items. The MCO for specific items, for example a venue ticket, can be based on historical venue data, staffing requirements, expected concession/person, maintenance, artist fees etc., and it typically represents a break even cost of sale of any item.

The user devices 112a or 112b, (symbolically represented by a single user device and collectively referred to as ‘user devices 112’ or a ‘user device 112’), are configured with a user interface of the online auction application (see, 122) for participating in the online auction process. The user device 112 accesses the plurality of items and item attributes from the server 116, which provides item details by accessing from the auction database 118. The communication between the user device 112 and the server 116 is carried through a network 114. One skilled in the art may recognize that the network 114 is a wireless communication means through which data is communicated. There can be various types of the networks 114, such as intranet, Local area network (LAN), Wide area network (WAN), cellular network, Wi-Fi, wimax and the like. One preferred example of the network 114 is the Internet, which is a combination of various types of communication means. The plurality of items and corresponding item attributes are displayed on the user device 112. Each user with respective user device 112 can bid for at least one item. With respect to the present context, a bid may include a maximum payment value that a user is willing to pay for the at least one item. For example, the bid may include a payment value or bid amount and the number of items (quantity) that the user wants to purchase. The bid may also include information of preferred items by the user. In an example embodiment, the information of preferred items may include a scale of preference between two reference numbers for example between 1 to 10. The user bidding details including the desired quantity of items, payment value, and the preferred items (with a selected scale of preference), is sent to the server 116 via the network 114.

Further, based on the bidding details associated with the user, the server 116 calculates the bid value of the user and corresponding rank of user and updates the user rank (or bid rank) in the auction database 118. The server 116 now accesses item attributes (also interchangeably referred to as “item details”) and obtains the item ranking. Thereafter, the server 116 determines the winning bid for each item of the plurality of items available for the online auction. In one non-limiting embodiment, the winning bid can be determined based on a principle that the user with the highest rank gets the item(s) with the highest rank(s). For example, 10 users u1, u2, u3, u4, u5, c6, u7, u8, u9 and u10 with user rankings from 1 to 10, respectively, bid for tickets of a play, where ‘u1’ is the highest bidder and ‘u10’ is the lowest bidder in that order. In this example, it may be assumed that there are 10 tickets (t1, t2 . . . t10) of the play, where the tickets (t1, t2 . . . t10) are also ranked from 1 to 10, respectively. Now, the server 116 determines the user ‘u1’ as the winning bid for the seat with highest rank i.e. t1, ‘u2’ is determined as with winning bid for the next highest ranked seat i.e. t2, and so forth. It should be noted that such determination of the winning bid for the items may not be considered as limiting to the scope of the present disclosure, and there may be many methods which can be used for determining the winning bid, which are described or suggested in the present disclosure. For instance, additionally or alternatively, the server 116 may consider an input which suggests how many users have given preference for a particular item, in determining the winning bid for that item. For example, let's assume user with rank 1 has preferred an item with rank 2 instead of an item with rank 1, and user with rank 2 has added no preferences. In normal scenarios, rank 1 item should be assigned to user rank 1 and rank 2 item should be assigned to user rank 2, however, since the user rank 1 has preferred item rank 2, before deciding the winning bid for item rank 2, the server 116 considers preference given by user with higher rank, which is user rank 1. Hence, the server 116 determines the bid placed by the user rank 1 as the winning bid for item rank 2. Also, it is to be noted that the preference consideration is carried out as per the ranking priorities. For example, if both rank 1 and rank 2 users have given preference for the item with item rank 2, the user of rank 1 will be assigned with the winning bid for the item with item rank 2. In this manner, the server 116 calculates the winning bid for each of plurality of items. Also, the scale of preference for any particular items from the users is also taken into consideration for determining the winning bids for the items.

Once the winning bids for each of the items are determined, the server 116 determines a mapping of the items and winning bids for the items. For example, the mapping includes allocation of each item to a user corresponding to the winning bid for the item. In another embodiment, the mapping may be determined based on choice of items by the users in the order of their rankings. For example, the user device 112 is allowed to check the assigned item(s) and if not satisfied with the assigned item(s), then the user may further change to the desired item from the plurality of items. Thus, the system 100 captures profit in the primary marketing by extracting complete willingness to pay from the users for the items of their preferences.

FIG. 2A shows a simplified schematic representation of a user interface 200 of the online auction application 122 in a user device such as the user device 112 for placing a bid, in accordance with an example embodiment. The user device 112 (such as a smartphone) with a touch screen interface is shown in the FIG. 2A. As described with reference to FIG. 1, the online auction application 122 for placing a bid for one or more items is available on the user device 112.

In the illustrated example representation, the user interface 200 includes a header section 201, in which user specific details 202 and an auction period 204 are displayed. The user specific details 202 may be at least one representation specific to a user of the corresponding user device 112. In an example, the user specific details 202 may be any of personally identifiable information (PII) including name, picture, residential address and the like. The user specific details 202 are collected from the user prior to the beginning of the auction period 204. The auction period 204 provides information to keep the user informed about the remaining auction span, and it may have information such as start time and end time (i.e. a cut-off time) of the online auction. The user may place a bid and modulate (e.g., update) the placed bid only during the auction period 204. Any input post and/or prior the auction period 204 may be considered invalid.

Further, the user interface 200 has a bid section 205 including multiple actionable icons for assisting the user in placing his bid. For example, the bid section 205 includes actionable icons 206, 208 and 210. The actionable icon 206 provides the user an option to input an item type. The actionable icon 206 provides a text box, a form field or a drop-down menu, to select a desired item type from a set of item types. For instance, once the user selects the drop-down menu of the actionable icon 206, the set of item types are displayed, and the user can make a selection of the desired item type. In an embodiment, a scale of preference (between 1 to 10) may also be provided (not shown in FIG. 2A) in the user interface 200, for the user to specify the preference of the item for which he is bidding.

Further, the actionable icon 208 provides the user an option to input a number of items (quantity). The entry field of the actionable icon 208 may allow the user to enter a numerical value, or may allow the user to select a number from a drop-down menu consisting of numbers. If the user selects a number 10, it suggests that the user is interested in bidding for 10 items of a particular item type selected by the actionable icon 206. Further, the actionable icon 210 provides the user an option to provide a payment value that the user is willing to pay for the number of items selected via the actionable icon 208. The bid amount 210 is mentioned in the further section. For example, during auctioning of event tickets, the user may select ‘Front row’ in the item type (icon 206), give ‘6’ in quantity (icon 208) and ‘$70’ in payment value (icon 210).

In one embodiment, the user may only provide the quantity and payment value, and may not specify the item type. In another embodiment, the user interface 200 may also present a graphical representation of items and the user can make a selection of item(s) from the graphical representation and place the bids for the item(s) selected from the graphical representation.

The bid section 205 also includes an actionable icon such as a submit 212 for placing the bid. Once the user selects the submit 212, the bid details selected by the icons 206, 208 and 210 are sent to the server 116. The bid section 205 also has an option of adding a new bid (see, 214) using a field “add a bid 214”. When the user selects the add a bid 214 option, the user is presented with blank options in the icons 206, 208 and 210, and the user can provide the second bid. It should be noted that the second bid may be made for items of the different item type. Further, when the user selects the submit 212 option, the second bid is also sent to the server 116. In an implementation, there may be an option of save (see, 218) the bid, in which the user may be able to save the first bid for first item type, a second bid for the second item type, and submit the first and second bids via a single click to the server 116.

The bid section 205 also includes an option to view the items of the online auction. For instance, the bid section 205 includes an actionable icon i.e. a view interactive map 216. When the user selects the view interactive map 216, a representative graphical user interface (GUI) of the items is presented in another window (for example, in form of a pop-up window), from which the user may view the item details and make a selection of the items for the bidding. One example of the GUI is shown in FIG. 2B.

The user interface 200 also includes a footer section including option such as “update bid 220”, “cancel 222”, and “resell 224”. When the field update bid 220 is selected, the user may make changes in the bids placed by the user dynamically during the online auction process. By selecting the field, cancel 222, the user may be able to cancel the bids placed by the user while the auction is going on. Once the item is allocated to the user by the server 116, the user may be able to resell the items on the online auction platform by selecting the resell 224 option. For instance, when a user ‘John’ (a first user) is assigned with an event ticket at the close of the auction, John may be able to resell the event to another user ‘Smith’ at a resale payment value. In an example, once the platform receives a request of return of the item assigned to John, the platform allows electronically reselling the event ticket to Smith, and the platform further allows facilitating the refund payment to John based on the resale payment value received from Smith. Without loss of generality, if the resale payment value is less than or equal to the payment value paid by John, facilitating the refund payment by the platform comprises refunding the resale payment value to John. For instance, if Smith paid 10$ for the event ticket which was originally purchased by John in 12$, entire payment of 10$ is refunded to Smith. Further, without loss of generality, if the resale payment value more than the payment value paid by John, facilitating the refund payment by the platform comprises refunding the payment value to John and a predefined percentage of difference between the payment value and the resale payment value. For instance, if Smith paid 1.8$ for the event ticket which was originally purchased by John in 12$, entire payment of 12$ is refunded to Smith along with 50% of the difference amount i.e. 3$. Hence, John would get 15$ as a process of refund of the cancelled event ticket.

FIG. 2B shows a simplified schematic representation of a user interface displaying the interactive map view 216 of an event and details associated with each seat in the user device, in accordance with an example embodiment.

As shown in the interactive map view 216, a screen 252, a plurality of items such as a plurality of seats in five rows are shown. The seats are shown as seats of front row 254a, seats of second row 254b, seats of third and fourth rows 254c, 254d and seats of last row 254e. The server 116 may rank the seats with corresponding item rankings. For example, seats A3 and A4 of the first row 254a are ranked with item rankings 1, the seats A1, A2 and A5, A6 are ranked with item ranking 2. Further, the seats B3 and B4 of the second row 254b are ranked with item ranking 3 and the seats B1, B2 and B5, B6 are ranked with item ranking 4. Furthermore, the seats C1 to C6, and seats D1 to D6 of the third and fourth rows 254c, 254d are ranked with item ranking 5. Thereafter, the seats E1 to E6 of the last row 254e are ranked with the item ranking 6. It should be noted that the ranking provided with reference to the illustrated representation of FIG. 2B, is only for example purposes, and as mentioned earlier, a ranking is purely based on qualitative analysis of the items and event, and qualitative parameters for ranking may change over time or may be based on the type of event, time of event and other similar factors.

When the user makes a selection of one particular item say B5 in the row 254b, attributes of the seat B5 are displayed to the user, for example, item type, item ranking, make of the seat, distance from the screen, base value of the bid for seat, current user rank for the seat, etc. Also, augmented view of the event while the user is present on the seat B5, may also be displayed to the user. Such augmented view will help the user in making a decision whether the user should make a bid for the seat B5 or not. For instance, the user is capable of viewing and exploring the venue along with the seating location. This functionality would provide the user with an absolute venue and seating experience with the ability to see views and sight lines from the seat B5. Such functionality may be achieved through any virtual reality and/or augmentation based technologies known in the art or invented in the future.

In one embodiment, the user device is configured with an interactive venue mapping functionality, which is configured to show at least one seating location during the event corresponding to the entry ticket; and at least one view relative to the seating location.

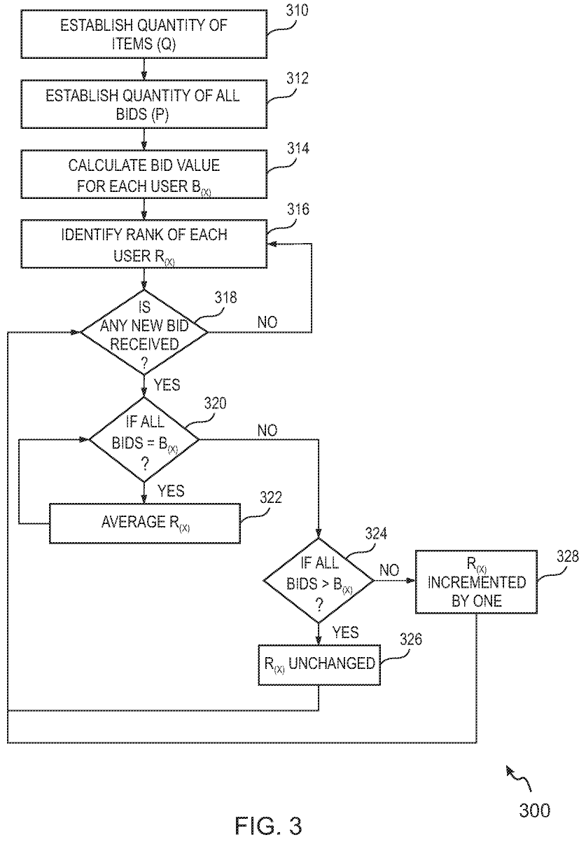

FIG. 3 shows an example embodiment of flow diagram of a method 300 of calculation of rank of the user and dynamic updating of the rank, in accordance with an example embodiment. The various steps and/or operations of the flow diagram of the method 300, and combinations of steps/operations in the flow diagram, may be implemented by, for example, hardware, firmware, a processor, circuitry and/or by the processing module in a server such as the server 116 and/or by a different electronic device associated with the execution of software that includes one or more computer program instructions. It is further noted that the steps provided in the flow diagram may not be executed in the same order as they are presented, and one or more steps can be executed in form of a single step and/or one step may be, performed in multiple sub-steps.

According to the present context, the online auction system runs a server-side logic that calculates the rank of the user using a function of payment value corresponding to respective bids. In detail, calculation of rank of the user (referred to as ‘user ranking’, ‘user rank or bid ranking’) includes dynamic execution of multiple steps from operations 310 to 328. At 310 and 312, the method 300 includes establishing the quantity of plurality of items, and establishing quantity of all bids received from the users. Let's assume, a total number of items in the online auction is represented by ‘Q’ (e.g., Q=310) and quantity of all bids are represented by ‘P’ (e.g., P=320). Each user submits his/her respective bid for at least one item out of ‘Q’. The auction system (i.e. the server 116) calculates bid of user ‘B(x)’ for each user at 314 by using a function of payment value and a number of items for which the user has bid. For instance, the auction system divides the received bid ($) amount (payment value) ‘Y’ by a quantity of items ‘D’ to calculate the bid of the user, as follows:

$$Bid value of user [ B ( x ) ] = \frac{Received bid ( Y )}{Quantity of items ( D )}$$

For example, if the received bid (payment value) is $500 for 5 items, then the bid value of the user is $100 per item. Similarly, the auction system calculates bid values corresponding to bids received from all users. At 316, the server 116 identifies the rank of each user R(x). For example, the highest bid of the user amongst all will be assigned with the highest rank, next highest bid of the user will be assigned with next highest rank and so forth. In one embodiment, during the auction period (time between auction start and end), every user or bidder reserve the capacity to view their respective present rank and is able to increase his/her bid value. Hence, there is a dynamic change in the bid of user Bx, which requires dynamic updating of rank of user R(x).

In an example, if a new bid Bn is received, the overall user rankings of all existing users (who have already bid) may be affected due to the new bid Bn. For example, if the new bid B(n) is received at 318, the method 300 proceeds to 320, otherwise the method 300 remains at 316. At 320, if the bid B(n) is equal to B(x) (where x is variable and represents ranks of different users who have already submitted their bids), Rn (where x=n) is averaged at 322 with the new bid Bn, and other bids Rx (x is not equal to n) remain unchanged (as shown at 326). However, if the Bn is not equal to any of the B(x), then the method 300 proceeds to 324. At 324, if a ranking for a B(x) is greater than Bn, the method 300 proceeds to 326. AT 326, R(x) for the B(x) remains unchanged. At 324, if a ranking of a B(x) is smaller than Bn, then the method 300 proceeds to 328, where R(x) for the B(x) is increased by one (i.e. ranking is decreased). For example, if there are 5 existing bids from 5 users for 6 items, and the bid values are $11, $12, $13, $14 and $15. If a new bid of $13.5 is placed by a sixth user, user rankings of the users who placed bids of $15 and $14 remain unchanged, i.e. their ranking remains 1st and 2nd, respectively. However, rankings of those users who placed bids of $13, $12 and $11 are increased by one, for example, their rankings are changed from 3rd, 4th, 5th to 4th, 5th and 6th, and the sixth user with the bid $13.5 is ranked as 3rd.

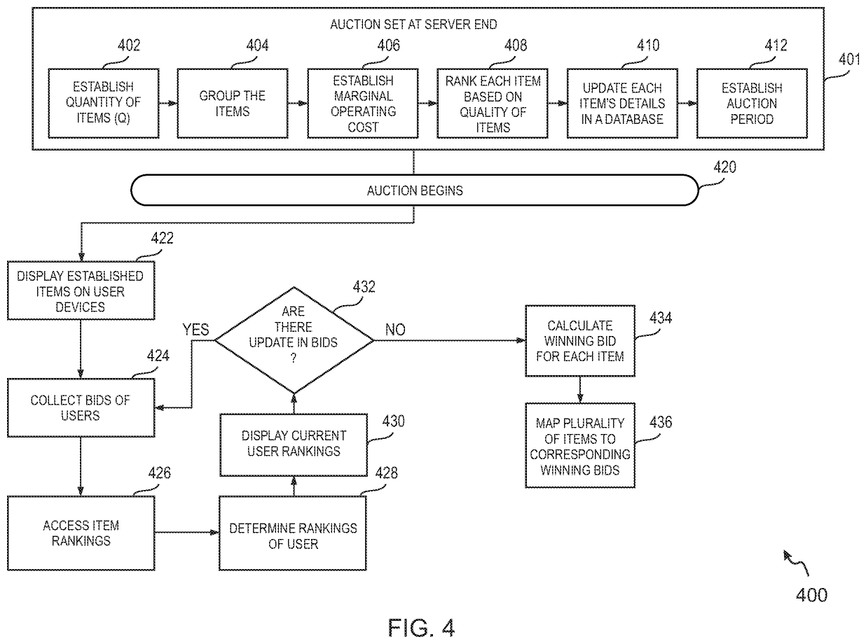

An example representation of overall process involved in the online auction is shown in FIG. 4. Referring now to FIG. 4, a simplified representation of a process 400 is shown, in accordance with an example embodiment.

FIG. 4 shows a flow diagram representing an auction execution process 400 of a plurality of items, in accordance with at least some example embodiments. The various steps and/or operations of the flow diagram, and combinations of steps/operations in the flow diagram, may be implemented by, for example, hardware, firmware, a processor, circuitry and/or by the processing module in a server such as the server 116 and by a smart user device such as the user device 112 associated with the execution of software that includes one or more computer program instructions. It is further noted that the steps provided in the flow diagram may not be executed in the same order as they are presented, and one or more steps can be executed in form of a single step and/or one step may be performed in multiple sub-steps.

In the auction execution process 400, the auction for the plurality of items includes dynamic execution of multiple steps from operations 402 to 436. The server (e.g., the server 116) sets up the online auction (see, 401) at the server end. Setting up the online auction includes performing multiple operations from 402 to 412. At 402, the server establishes the total quantity of items (Q) that are to be auctioned. Once established, the items are further differentiated or grouped into multiple item types at 404. In an example, a grouping of items is based on the quality of the items or tier of the items. Further, each item from each item type is assigned with a base price, where the base price may be pre-assigned by a third party server (e.g., the third party server 120). In one embodiment, at 406, the base price may be assigned by the server based on the calculated marginal operation cost (MCO). Due to the application of the MCO, the base price for every item of every item type may be different. For example, during auction process of tickets for a concert, there may be two item types, ground floor tickets and first floor tickets. For instance, all ground floor tickets are uniformly priced at $80 and all first floor tickets are priced at $60. In an example, if a user orders more than one ticket at a time, say 3 ground floor tickets, the base price may be reduced to $78 per ticket, and similarly, if the user orders 5 ground floor tickets, the base price may be $75 per ticket.

At 408, after establishing the base price, each item is ranked. Ranking of items is based on the qualitative analysis of items (see, FIG. 2B). In one example, the ranking of items may be directly received from the third party server (such as the third party server 120). At 410, a ranking of each item along with other item's details, such as item type, handicap access, price based on the item type, and the like are stored in the database 118. The stored item details are specific to a particular item of an item type. At 412, an auction period is established by the server with a definite start and end time (i.e. a cut-off time). The auction process takes place during the auction period. The auction period is further reflected in every user device such as the user device 112. The users can access the online auction application 122 in their respective user devices 112 and start bidding during the auction period.

As soon as the auction period begins (see, 420), at 422, the auction execution process 400 includes displaying the established items on the user devices of various users. The display of each item includes a display of item specific details such as item rank, item type, base price and the like.

At 424, the server collects bids of various users. In a bid from a user, the user may select a number of items and may place his/her bid (payment value) for the selected number of items. In an example, the user may place his/her bid for preferred items of a preferred item type. Once the bid is placed in the online auction application 122 of the user device 112, the bid details (including payment value for a specific number of items), are communicated to the server. In an embodiment, the user bid may consist of more than one subset of items. For instance, bids from the user can include a first bid and a second bid, wherein the first bid may be for at least one first item from a first type of items, and the second bid may be for at least one second item from a second type of items. In an example, there may be 30 seats in a movie theatre, and the user may want to bid for 20 seats where all seats may not be necessarily of the same item type. In this example, the user may bid at per unit price of $10 for seats 1-10 (in ground floor) and $8 for seats 11-20 (in the first floor). Further, in one embodiment, the server collects deposits for all the bids placed by various users in the online auction. The deposits are collected so that if the user wins the bid for item(s), the deposit amount can be used towards the payment; and if the user does not win the bid for the item (s), the deposit amount is returned to the user at the time of auction close.

The server accesses the ranks of the item(s) selected by the users in the database (at 426). In one embodiment, the server may prompt the users for confirming their bids and details associated with the bids (e.g., payment value, quantity, item type, preferred items, item rankings and the like) that were placed at 424.

At 428, the server calculates the ranks of the users based on a function of their bids i.e. the payment value and quantity of items provided in respective bids. In an example, for one user's bid, the server may calculate the user ranking (or bid ranking) by dividing the payment value by the quantity to get the bid value and the user rank is assigned as per the bid value (see, FIG. 3). It should be noted that the bid rankings (or user rankings) are calculated for each bid received on the action platform by the server. At 430, the current user ranks are dynamically displayed to the users within the online auction application 122 in respective user devices 112.

At 432, the server detects if there are updates in the bids of the one or more users. It should be noted that the operations 424 to 430 are performed simultaneously for all the users participating in the online auction process. If any update in the bids of the users are detected at 432, the process 400 repeats the steps of 424 to 430. In case of no update in the bids of the users or at the closure of the bidding part of the auction process (i.e. at the cut-off time), the method continues to 434.

At 434, the winning bids for all the items of the auction process are determined. The winning bid for an item is determined as a function of all the bids received for the item, ranks of the users participating in the online auction, item ranking of the item, and information of any preferences received for the item as part of bids received from various users during the online auction.

At 436, a mapping of the plurality of items of the online auction and a winning bid for each of the plurality of items is determined, and such mapping is presented to all of the users participating in the online auction. In an example, the mapping includes an item and name (or other details) of a user whose bid has been determined as the winning bid against the item. For example, if tickets for an event are being auctioned, all tickets Q are being ranked, where G(1) is the best ticket and G(Q) is the least preferred ticket according to the server. In the mapping, the server assigns G(1) to G(Q) to the users holding ranks R(1) to R(Q). and any user outside Q, that is R(Q+1) . . . R(P), ‘P’ being a total number of bids received, return bids or deposits B(Q+1) . . . B(P) to respective users. Thereafter, the items are allocated or assigned to the users based on the mapping.

In an example, the details are returned to the user for the user to update the payment value (if required). In an example, every top bidder is assigned an item which is ranked based on the server end quantitative differentiation or centralized differentiation. Also, the users who are not assigned with any item i.e. their bids are not considered as winning bids, are returned with their payment values initially paid in form of deposits.

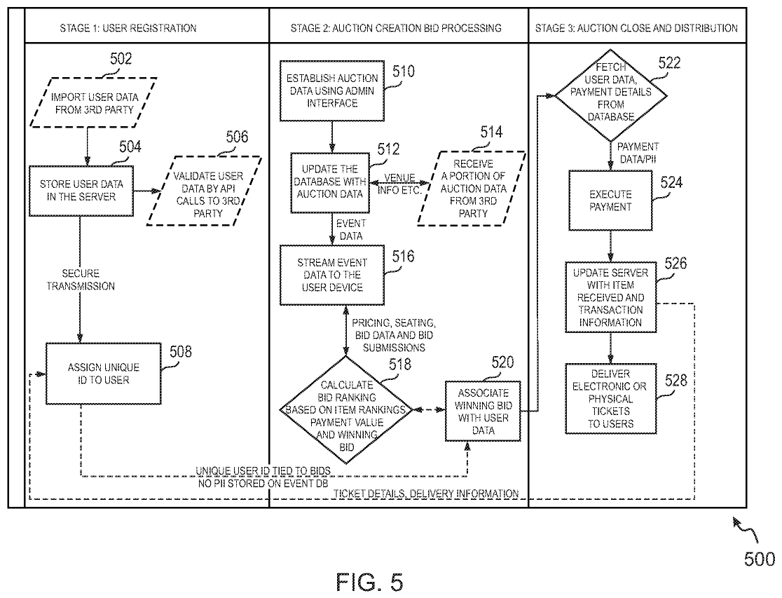

A simplified schematic representation of a process 500 is shown in FIG. 5, in accordance with an example embodiment, which can be performed by the server 116 in communication with the database 118, the third party server 120 and the user device 112. Referring now to FIG. 5, a simplified representation of a process 500 illustrating continuous auction execution with respect to auctioning of seats for an event is shown, in accordance with an example embodiment of the present disclosure. In the illustrated example embodiment, the continuous auction includes three major stages, stage 1—User registration; stage 2—Auction creation and bid processing; and stage 3—Auction close and distribution.

Under stage 1, as shown in operation 502, the user data or user specific details are imported from a third party. Examples of the third party may be the user device 112. At 504, the user data and user specific details are stored on the server. Examples of the user data may include, but not limited to, user PII, payment details and authentication details related to data security for the user. At 506, some of the user-specific details, or identity of the user may be validated by making API calls to respective third party agencies, as a process of registration of the user with the auction platform. For instance, a tax identification number of the user may be verified from agencies handling taxation in a particular geography. At 508, a unique ID is assigned to the user, and a profile of the user is created with the auction platform. The assigned unique ID is stored along with the user data (e.g., PII, payment details, biometric details, and other inventory), in the database associated with the server.

In stage 2, at server end using admin interface (see, 510), the auction data is established by an admin of the online auction process. The auction data may include, but is not limited to, event data, a quantity of items (e.g., number of seats), types of items (e.g., tiers), etc. At 512, the database is updated with the auction data established by the admin. In one embodiment, a portion of the auction data is sourced (see, 514) from the third party, for example, systems associated with the event organizers. Some other examples of the third party may be compliance agencies, production units or different support agencies for the event organizers.

According one example of the present embodiment, during the online auction process, the well-established portion of auction data (such as event data) is streamed to the user device 112, where the event details, seating, and pricing per seat is displayed on the user interface from where the user bids for the seat(s) of his/her choice (see, 516).

At 518, the server calculates the ranks of the user's bid (bid rankings) for all users based on factors such as item rankings, payment values submitted in the bids of the users, and preferences of items selected by the users as part of the bidding process. The step 518 includes determining the winning bids for each of the items of the auction. The winning bids are associated (see, 520) with the respective user data such as user ID in the database.

In stage 3, in order to distribute assigned seat to the user, the user data including PII is fetched (see, 522) from the database. The payment for the assigned seat is executed (see, 524). Further, the server updates (see, 526) user data with items received and transaction information. Thereafter, seats are delivered to the user in the form of electronic tickets or physical tickets (see, 528). Delivery details of the tickets are also updated in the database along with the user data.

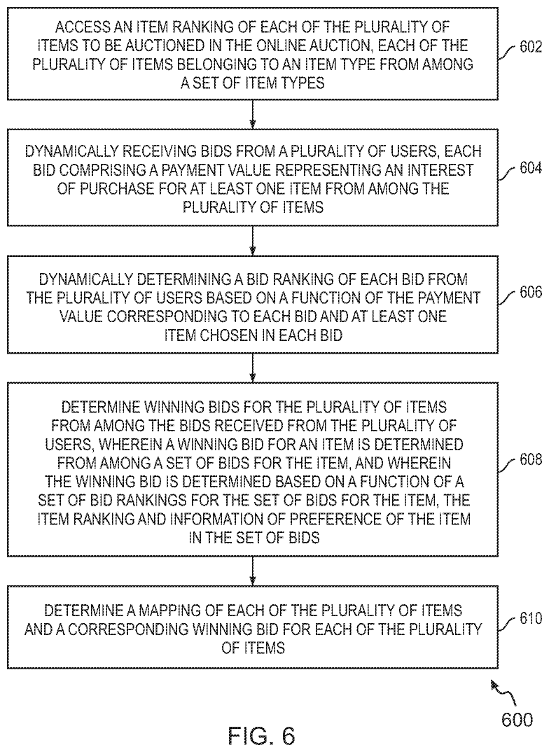

FIG. 6 is a flow diagram of a method 600 for facilitating an online auction of a plurality of items, in accordance with an example embodiment of the present disclosure. At 602, the method 600 includes the step of accessing an item ranking of each of the plurality of items to be auctioned in the online auction, where each of the plurality of items belongs to an item type from among a set of item types. In one embodiment, accessing of an item ranking may be achieved by accessing item rank that is calculated by a server based on qualitative analysis. Alternatively or additionally, an admin at the server can directly feed the item ranking to the server.

At 604, the method 600 includes the step of dynamically receiving bids from a plurality of users or user devices, where each bid comprises a payment value or bid amount for at least one item from among the plurality of items. In one embodiment, the bid may also include a selection of a preferred item type or preferred tier. As the auction platform receives the bid throughout the auction period, the user is allowed to check his/her ranks in real time and dynamically update the bid throughout the process. Further, at 606, the method 600 includes dynamically determining a bid ranking of each bid from the plurality of users based on a function of the payment value corresponding to respective bid and the at least one item chosen (e.g., a number of items) in the bid. In one embodiment, the function of payment value is a division of bid amount (SD) by the quantity of items (Y). In an embodiment, the bid of the user also includes information of preference of items for the user.

At 608, the method 600 includes determining winning bids for the plurality of items. A winning bid for an item (item 1) is determined from among a set of bids for the item received from the plurality of users. The determination of the winning bid for the ‘item 1’ is based on a function of payment values associated with the set of bids for the ‘item 1’, the item ranking of the ‘item 1’ and information of preference of the ‘item 1’ in the set of bids. For example, if there are 100 items, each of different item type, and for an item ‘X’, there are 10 bids (i.e. set of bids) out of 1000 total bids. Without loss of generality, in an example, the winning bid for the item ‘X’ may be chosen from among those 10 bids who has bid for the item ‘X’. Further, among 10 bids for the item ‘X’, if there are different preferences of the item ‘X’ provided in respective bids, a weightage may be given to the preference values for the item ‘X’ along with a superior weightage given to bid value. In this example, based on the preference values and the bid values and their weightage, one bid among 10 bids may be selected as the winning bid for the item ‘X’.

At 610, the method 600 thereafter includes determining a mapping of each of the plurality of items and a corresponding winning bid for each of the plurality of items. The mapping is used to allocated or assign the items to respective users who are associated with the winning bids. For instance, once the server 116 provides the mapping, the sellers of the items assigns the items to users who have the winning bids for the items.

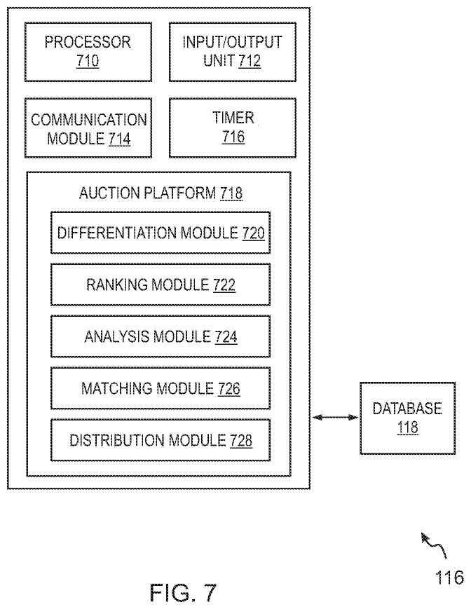

Furthermore, FIG. 7 shows simplified block diagram representation of a server, such as the server 116 for facilitating an online auction of items, in accordance with an example embodiment of the present disclosure. The server 116 is configured with a processor 710, an input/output unit 712, a communication module 714, a timer 716 and an auction platform 718.

The processor 710, which is configured to execute instructions as per the instructions from the auction platform 718, where the instructions may be stored in the database 118. The processor 710 may be embodied in a number of different ways. The processor 710 may be embodied as a multi-core processor, a single core processor; or combination of multi-core processors and single core processors. For example, the processor 710 may be embodied as one or more of various processing means such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the multi-core processor may be configured to execute instructions that can be accessible to the processor 710. Alternatively, the processor 710 may be configured to execute hard coded functionality. As such, whether configured by hardware or software methods, or by a combination thereof, the processor 710 may represent an entity, for example, physically embodied in circuitry, capable of performing operations according to various embodiments while configured accordingly. For example, if the processor 710 is embodied as two or more of an ASIC, FPGA or the like, the processor 710 may be specifically configured hardware for conducting the operations described herein. Alternatively, as another example, if the processor 710 is embodied as an executor of software instructions, the instructions may specifically configure the processor 710 to perform the algorithms and/or operations described herein when the instructions are executed.

Further, the server 116 is configured with the input/output unit 712, which is configured to feed the server 116 with data for processing and reproduce or display the processed data. Keyboard, mouse, touch screen, display screen, speaker, CD-RW drive, DVD-RW drive, and flash drive are some example output and input/output devices. The communication module 714, disposed on the server 116, is configured to enable data communication between the server 116 and the user device such as the user device 112 (shown in FIG. 1) or the server 116 and the third party server (such as the third party server 120 shown in FIG. 1). The communication module 714 can be any wireless communication protocols including, but not limited to, Wi-Fi module, GSM module and the like. The processor 710 sets up the auction process using the auction platform 718, where the plurality of items, item types and item rankings are established.

The auction platform 718 includes a differentiation module 720 that helps the processor 710 to analyze the plurality of items based on the quality of items and accordingly group the items into different item types. Further, the processor 710 establishes a base price for each item based on the grouping. In one embodiment, the processor 710 may access a marginal operational cost (MCO) for each additional item of a specific category, where the base price for plurality of items is decided as equal to the calculated MCO. The MCO can be readily available to the processor 710 as part of the known information, where the MCO, in case of a ticket, is generally based on historical venue data, staffing requirements, expected concession/person, maintenance, artist fees etc.

By considering, the quantitative analysis and established marginal operation cost, the processor 710 ranks each item of the plurality of items, to be auctioned in the online process, with the help of a ranking module 722. The ranked items along with item details are updated in the database 118 and auction period, with a defined start and end time, is established. As soon as the auction time begins, which is counted by the timer 716, multiple users are able to access the auction platform 718 through their respective user interfaces configured within their corresponding user devices. The server 116 further receives multiple bids from the multiple user devices for the specified number of items. The server 116 calculates the rank of the user for each bid received by a respective user. The rank of the user is identified by the help of an analysis module 724. Further, the auction platform 718 includes a matching module 726 that helps the processor 710 to calculate the winning bid for each of the items. In an example, the winning bid may be calculated by mapping the user with certain user rank (say Rx) with the corresponding item of the same rank (Qx). In the same example, a bid placed by the user (Rx) is considered as winning bid for the item (Qx) The mapping process is repeated for all the items, where the server 116 assigns each of the items with its corresponding user based on the mapping of item and user ranks. The matched items are now distributed with the help of a distribution module 728 among the users.

In one embodiment, if the distributed item(s) are tickets to a specific event, then the online auction system may include biometric ticketing functionality. The biometric ticketing functionality includes tickets being linked to the specific user using a host of pre-existing biometric technologies. When the user enters a venue of the event using the distributed online tickets, the user will be required to confirm his/her identity via biometric details, such as fingerprint, retina scan, facial recognition and the like. Alternatively, or additionally, the users are required to confirm their details using a valid identity proof issued by a legitimate authority.

In one embodiment, the auction platform 718 includes an interactive mapping module (not shown), which provisions an interactive venue mapping functionality to the user devices. In case of items being entry tickets to a venue, the interactive venue mapping is configured to show seating locations during the event corresponding to the entry tickets, and at least one view of the event relative to the seating locations. Hence, the user device is capable of viewing and exploring the venue along with the seating location while the online auction process. This functionality would provide the user with an absolute venue and seating experience with the ability to see views and sight lines from the seating. Such functionality may be achieved through any virtual reality and/or augmentation based technologies known in the market.

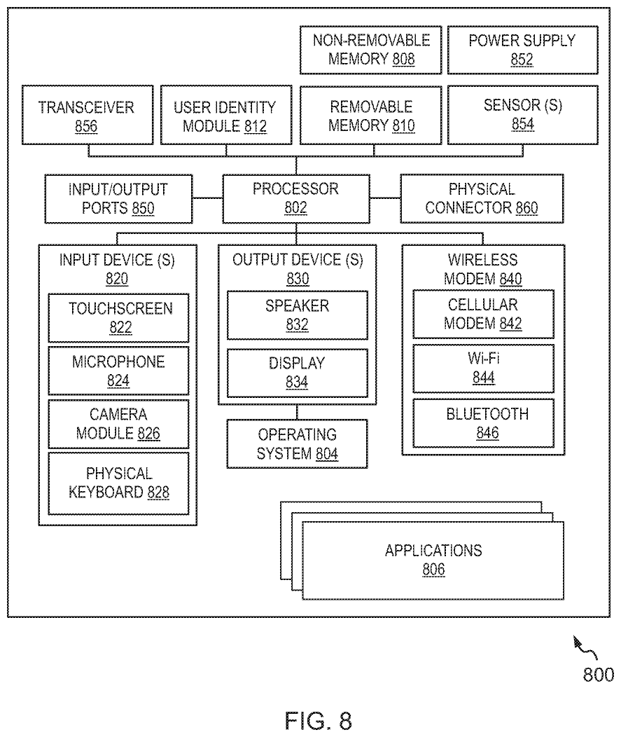

FIG. 8 shows a user device 800 capable of implementing the various embodiments of the present disclosure related to online auction process. The user device 800 may correspond to the user device 112 shown in FIG. 1. The user device 800 is depicted to include one or more applications 806 (such as the online auction application 122). The user device 800 as illustrated and hereinafter described is merely illustrative of one type of device and should not be taken to limit the scope of the embodiments. Further, some of the components described below in connection with that the user device 800 may be optional and thus in an example embodiment may include more, less or different components than those described in connection with the example embodiment of the FIG. 8. As such, among other examples, that the user device 800 could be any of a mobile electronic device, for example, cellular phones, tablet computers, laptops, mobile computers, desktop computers, personal digital assistants (PDAs), mobile televisions, mobile digital assistants, any combination of the aforementioned, and other types of communication or multimedia devices with a touch screen interface.

The illustrated user device 800 includes a controller or a processor 802 for performing such tasks as signal coding, data processing, image processing, input/output processing, power control, and/or other functions. In an embodiment, the processor 802 may be embodied as one or more of various processing devices, such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. The processor 802 is capable of executing the stored machine executable instructions in the memory (e.g., a non-removable memory 808 or a removable memory 810) or within the processor 802 or any storage location accessible to the processor 802.

The processor 802 is configured to perform the various operations as explained with reference to methods 300 and 500. The user device 800 includes an operating system 804 that controls the allocation and usage of the components of the user device 800 and support for one or more applications programs (see, applications 806).

The illustrated user device 800 includes one or more memory components, for example, the non-removable memory 808 and/or the removable memory 810. The non-removable memory 808 can include RAM, ROM, flash memory, a hard disk, or other well-known memory storage technologies. The removable memory 810 can include flash memory, smart cards, or a Subscriber Identity Module (SIM). The one or more memory components can be used for storing data and/or code for running the operating system 804 and the applications 806. The one or more memory components can be used for storing data and/or code for running the operating system 804 and the applications 806. The user device 800 may further include a user identity module (UIM) 812. The UIM 812 may be a memory device having a processor built in. The UIM 812 may include, for example, a subscriber identity module (SIM), a universal integrated circuit card (UICC), a universal subscriber identity module (USIM), a removable user identity module (R-UIM), or any other smart card. The UIM 812 typically stores information elements related to a mobile subscriber. The UIM 812 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The user device 800 can support one or more input devices 820 and one or more output devices 830. Examples of the input devices 820 may include, but are not limited to, a touch screen 822 (e.g., capable of capturing finger tap inputs, finger gesture inputs, multi-finger tap inputs, multi-finger gesture inputs, or keystroke inputs from a virtual keyboard or keypad), a microphone 824 (e.g., capable of capturing voice input), a camera module 826 (e.g., capable of capturing still picture images and/or video images) and a physical keyboard 828. Examples of the output devices 830 may include, but are not limited to a speaker 832 and a display 834. Other possible output devices (not shown in the FIG. 8) can include piezoelectric or other haptic output devices. Some devices can serve more than one input/output function. For example, the touch screen 822 and the display 834 can be combined into a single input/output device.

A wireless modem 840 can be coupled to one or more antennas (not shown in FIG. 8) and can support two-way communications between the processor 802 and external devices, as is well understood in the art. The wireless modem 840 is shown generically and can include, for example, a cellular modem 842 for communicating at long range with the mobile communication network, a Wi-Fi compatible modem 844 for communicating at short range with an external Bluetooth-equipped device or a local wireless data network or router, and/or a Bluetooth-compatible modem 846. The wireless modem 840 is typically configured for communication with one or more cellular networks, such as a GSM network for data and voice communications within a single cellular network, between cellular networks, or between the user device 800 and a public switched telephone network (PSTN).

The user device 800 can further include one or more input/output ports 850, a power supply 852, one or more sensors 854 for example, an accelerometer, a gyroscope, a compass, or an infrared proximity sensor for detecting the orientation or motion of the user device 800, a transceiver 856 (for wirelessly transmitting analog or digital signals) and/or a physical connector 860, which can be a USB port, IEEE 1294 (FireWire) port, and/or RS-232 port. The illustrated components are not required or all-inclusive, as any of the components shown can be deleted and other components can be added.

The aforementioned online auction system (present disclosure) can benefit a wide range of businesses and event organizers. Without limiting the scope of various embodiments described herein, the primary consumers of the online auction system would be auction organizers, artists, venue managers, ticketing agencies. The beneficiaries of the disclosure are primarily the first-level sellers of the item being auctioned, as they are likely to accumulate significantly higher profits on the first round of items sale. The secondary beneficiaries of the disclosure are the consumers who would otherwise be unable to receive items due to limited quantities, while the secondary market siphons profit. The present disclosure allows those consumers an opportunity to pay what they are willing over a much larger timeframe. In addition to this, it allows consumers the ability to personalize and customize the item they are bidding for based on their preferences.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed:

1. A method for facilitating an online auction of a plurality of items, the method comprising:
accessing an item ranking of each of the plurality of items to be auctioned in the online auction, each of the plurality of items belonging to an item type from among a set of item types;
dynamically receiving bids from a plurality of users, each bid comprising a payment value representing an interest of purchase for at least one item from among the plurality of items;
dynamically determining a bid ranking of each bid from the plurality of users based on a function of the payment value corresponding to each bid and at least one item chosen in each hid;
determining winning bids for the plurality of items from among the bids received from the plurality of users, wherein a winning bid for an item is determined from among a set of bids for the item, and wherein the winning bid is determined based on a function of a set of bid rankings for the set of bids for the item, the item ranking and information of preference of the item in the set of bids; and
determining a mapping of each of the plurality of items and corresponding winning bid for each of the plurality of items.

2. The method as claimed in claim 1, further comprising assigning the plurality of items to users based on the mapping of the plurality of items and the winning bid for each of the plurality of items.

3. The method as claimed in claim 2, wherein the plurality of items is a plurality of entry tickets of an event, and wherein assigning an entry ticket of the plurality of entry tickets to a user comprises linking a biometric authentication of the user with the entry ticket for using the entry ticket at the event.

4. The method as claimed in claim 3, further comprising provisioning an interactive map in a user interface of a user device to the user showing at least:
a seating location during the event corresponding to the entry ticket; and
at least one view relative to the seating location.

5. The method as claimed in claim 2, further comprising:
receiving a request for return of the item assigned to a first user;
electronically reselling the item to a second user; and
facilitating a refund payment to the first user based on a resale payment value received from the second user.

6. The method as claimed in claim 5,
wherein if the resale payment value is less than or equal to the payment value paid by the first user, facilitating the refund payment comprises refunding the resale payment value to the first user; and
wherein if the resale payment value is more than the payment value paid by the first user, facilitating refund comprises refunding the payment value to the first user and a predefined percentage of difference between the payment value and the resale payment value.

7. The method as claimed in claim 1, wherein determining the winning bid is performed based on a cut-off time of the online auction.

8. The method as claimed in claim 1, wherein accessing the item ranking comprises determining the item ranking based on qualitative analysis of each of the plurality of items.

9. The method as claimed in claim 1, wherein a bid from a user comprises a first bid for at least one first item of a first item type and a second bid for at least one second item of a second item type.

10. The method as claimed in claim 1 further comprising calculating a bid value of a user by dividing a total payment value with that of a quantity of items.

11. The method as claimed in claim 10, wherein dynamically determining the bid ranking for each bid comprises dynamically updating the bid ranking for each bid with a change in the bid of user or with receipt of a new bid.

12. The method as claimed in claim 1, wherein dynamically receiving the bid for an item from a user comprises updating the bid with an updated payment value prior to determining the winning bid for the item, and wherein a bid ranking of the bid is updated based on the updated payment value.

13. The method as claimed in claim 12, further comprising facilitating display of the bid ranking of each bid to the plurality of users.

14. The method as claimed in claim 1, further comprising assigning a marginal operating cost for the plurality of items.

15. The method as claimed in claim 1, further comprising facilitating return of payment values to those users of the plurality of user whose bids are not part of the winning bids.

16. An online auction system, comprising:
a communication module for communicating with a plurality of user devices;
a database comprising stored instructions related to an online auction;
a processor configured to execute the stored instructions to perform a method comprising at least:
accessing an item ranking of each of a plurality of items to be auctioned in the online auction, each of the plurality of items belonging to an item type from among a set of item types;
dynamically receiving bids from a plurality of users, each bid comprising a payment value representing an interest of purchase for at least one item from among the plurality of items;
dynamically determining a bid ranking of each bid from the plurality of users based on a function of the payment value corresponding to each bid and at least one item chosen in each bid;
determining winning bids for the plurality of items from among the bids received from the plurality of users, wherein a winning bid for an item is determined from among a set of bids for the item, and wherein the winning bid is determined based on a function of a set of bid rankings for the set of bids for the item, the item ranking and information of preference of the item in the set of bids; and
determining a mapping of each of the plurality of items and corresponding winning bid for each of the plurality of items.

17. The system as claimed in claim 16, wherein the processor is further configured to assign the plurality of items to users based on the mapping of the plurality of items and the winning hid for each of the plurality of items.

18. The system as claimed in claim 17, wherein the plurality of items is a plurality of entry tickets of an event, and wherein assigning an entry ticket of the plurality of entry tickets to a user comprises linking a biometric authentication of the user with the entry ticket for using the entry ticket at the event.

19. The system as claimed in claim 18, wherein the processor is further configured to provision an interactive map in a user interface of a user device to the user showing at least:
a seating location during the event corresponding to the entry ticket; and
at least one view relative to the seating location.

20. The system as claimed in claim 17, wherein the processor is further configured to:
receive a request for return of an item assigned to a first user;
electronically resell the item to a second user; and
facilitate a refund payment to the first user based on a resale payment value received from the second user.
